(19) United States
(12) Patent Application Publication
(10) Pub. No.: US 2010/0227577 A1
(43) Pub. Date: Sep. 9, 2010

(54) APPARATUS AND METHOD FOR IMPROVING LINEARITY OF TRANSMITTER

(75) Inventors: Jong-Wook Zeong, Seoul (KR); Han-Gue Park, Seoul (KR); Bum-Man Kim, Seoul (KR); Jae-Sup Lee, Yongin-si (KR); Jin-Sung Choi, Pohang-si (KR)

Correspondence Address: THE FARRELL LAW FIRM, LLP, 290 Broadhollow Road, Suite 210E, Melville, NY, 11747, US

(73) Assignees: Samsung Electronics Co., Ltd., Suwon-si (KR); Postech Academy-Industry Foundation, Pohang-si (KR)

(21) Appl. No.: 12/717,562

(22) Filed: Mar. 4, 2010

(30) Foreign Application Priority Data
Mar. 5, 2009 (KR) 10-2009-0018750

(51) Int. Cl. H04B 1/04

(52) U.S. Cl. 455/127.2

(57) ABSTRACT

Improvement of linearity of a transmitter is provided, by a transmission method that includes, when receiving a transmit signal, generating, at a modulation signal generator, a modulation signal modulated from the transmit signal, an average output level and an amplitude with respect to the modulation signal; receiving, at a Read Only Memory (ROM), the average output level and generating a peak amplitude; and generating, at an amplitude shaper, a gain value using the peak amplitude and the amplitude and generating magnitude information by adding an offset value.

### PRIORITY

The present application claims priority under 35 U.S.C. §119(a) to a Korean patent application filed in the Korean Intellectual Property Office on Mar. 5, 2009, and assigned Serial No. 10-2009-0018750, the entire disclosure of which is incorporated herein by reference.

### BACKGROUND OF THE INVENTION

1. Field of the Invention

The present invention relates to an apparatus and a method for achieving a high gain and improving linearity and efficiency of a power amplifier by compensating a gain change according to variation of supply voltage in a transmitter.

2. Description of the Related Art

To improve efficiency of a power amplifier, the drain (or the collector) voltage can be changed according to the magnitude of the input signal envelope.

However, when the drain of the power amplifier reaches a knee region, non-linear characteristics are revealed. Thus, the magnitude of the envelope is modified to prevent the power amplifier from operating in a non-linear manner.

Therefore, an envelope signal that is less than a specific threshold voltage is altered to a constant voltage, and an envelope signal greater than the threshold voltage is processed using the conventional envelope process. Hence, efficient amplification is achieved without losing the linear characteristics and compensation is provided for gain decrease of the power amplifier in the low supply voltage region.

The method for changing the envelope magnitude to prevent the non-linear operation of the power amplifier can employ a pre-emphasis structure through an inverse frequency response to compensate the non-linear characteristics of a supply modulator. Thus, the envelope signal having a wide bandwidth is linearly amplified and fed to the power amplifier.

When the envelope signal of less than the specific threshold voltage is altered to the particular (constant) voltage, an abrupt change will occur in the time domain. In the frequency domain, this abrupt change is represented as the high frequency conversion. A resulting non-linearity will occur at the output stage of the power amplifier.

To address this shortcoming, a low frequency pass filter is additionally required after the envelope signal conversion, which disadvantageously consumes additional power and increases a delay of the envelope path.

Mostly, as the supply voltage decreases, the gain of the power amplifier reduces. Hence, when the supply voltage is regulated based on the envelope magnitude, the gain according to the envelope magnitude will change. When the supply voltage is small, a value of a parasitic component will increase and the gain decreases.

When an envelope signal of less than the specific threshold voltage is converted to the constant voltage, the gain in this region is compensated to some degree but the region that is controlled based on the envelope signal is not compensated. In addition, when a pre-emphasis filter can be used in place of a digital pre-distortion scheme is frequently used, the filter with fixed characteristics is vulnerable to environment change.

### SUMMARY OF THE INVENTION

An object of the present invention is to substantially solve at least the above problems and/or disadvantages and to provide at least the advantages described below.

To address the above-discussed deficiencies of conventional systems, the present invention provides an apparatus and method that improves transmitter linearity.

Another aspect of the present invention provides an apparatus and method that achieves high gain and improves linearity and efficiency of a power amplifier by compensating a gain change according to variation of supply voltage in a transmitter.

According to one aspect of the present invention, a transmission method for improving linearity of a terminal includes when receiving a transmit signal, generating, at a modulation signal generator, a modulation signal modulated from the transmit signal, an average output level and an amplitude with respect to the modulation signal; receiving, at a Read Only Memory (ROM), the average output level and generating a peak amplitude; and generating, at an amplitude shaper, a gain value using the peak amplitude and the amplitude and generating magnitude information by adding an offset value.

According to another aspect of the present invention, an apparatus of a terminal for transmitting by improving linearity includes a modulation signal generator for, when receiving a transmit signal, generating a modulation signal modulated from the transmit signal, an average output level and an amplitude with respect to the modulation signal; a ROM for receiving the average output level and generating a peak amplitude; and an amplitude shaper for generating a gain value using the peak amplitude and the amplitude and generating magnitude information by adding an offset value.

According to yet another aspect of the present invention, a transmission method for improving linearity of a base station includes when receiving a transmit signal, generating, at a modulation signal generator, a modulation signal modulated from the transmit signal, an instantaneous output level and an amplitude with respect to the modulation signal; receiving, at a ROM, the instantaneous output level and generating an offset; and generating, at an amplitude shaper, magnitude information by adding the amplitude and the offset.

According to still another aspect of the present invention, an apparatus of a base station for transmitting by improving linearity includes a modulation signal generator for, when receiving a transmit signal, generating a modulation signal modulated from the transmit signal, an instantaneous output level and an amplitude with respect to the modulation signal; a ROM for receiving the instantaneous output level and generating an offset; and an amplitude shaper for generating magnitude information by adding the amplitude and the offset.

Other aspects, advantages, and salient features of the invention will become apparent to those skilled in the art from the following detailed description, which, taken in conjunction with the annexed drawings, discloses embodiments of the invention.

### BRIEF DESCRIPTION OF THE DRAWINGS

The above and other objects, features and advantages of the present invention will become more apparent from the following detailed description when taken in conjunction with the accompanying drawings, in which like reference numerals represent like parts:

FIG. 1 is a chart illustrating the relationship of offset voltage and input envelope signal according to an exemplary embodiment of the present invention;

FIG. 2A illustrates the relationship of input and output functions in a time domain according to a conventional Envelope Elimination and Restoration (EER) method;

FIG. 2B illustrates the relationship of input and output functions in a time domain according to conventional systems;

FIG. 2C illustrates the relationship of input and output functions in a time domain according to an embodiment of the present invention;

FIG. 3A is a block diagram illustrating a control circuit of an embodiment of the present invention;

FIG. 3B is a block diagram illustrating an amplitude shaper of an embodiment of the present invention;

FIG. 4 is a chart illustrating conversion of an envelope signal based on an average output power level according to an embodiment of the present invention;

FIG. 5A illustrates load lines in the envelope shaping of the power amplifier of FIG. 3, according to an embodiment of the present invention;

FIG. 5B is a chart showing the modified envelope of the present invention, compared to conventional Envelope Elimination and Restoration (EER) systems;

FIG. 6A is a block diagram illustrating a control circuit according to another embodiment of the present invention;

FIG. 6B is a block diagram illustrating an amplitude shaper of the control circuit of FIG. 6A;

FIG. 7 is a flowchart showing the operation of an envelope control circuit according to an embodiment of the present invention; and

FIG. 8 is a flowchart showing the operation of the envelope control circuit according to another embodiment of the present invention.

### DETAILED DESCRIPTION OF EMBODIMENTS OF THE INVENTION

Preferred embodiments of the present invention will be described herein below with reference to the accompanying drawings. In the drawings, the same or similar elements are denoted by the same reference numerals even though they are depicted in different drawings. In the following description, well-known functions or constructions are not described in detail since they would obscure the invention in unnecessary detail.

In the following description, the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

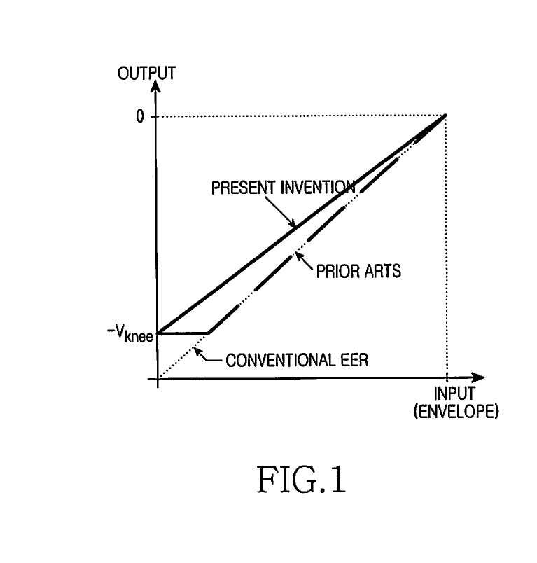

FIG. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communications system.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

In FIG. 1, the present invention supplies an offset voltage of −Vknee when the magnitude of an envelope signal is zero, and supplies the offset voltage of ‘0’ when the magnitude of the envelope signal peaks. For the envelope signals between zero and the peak, the present invention linearly supplies the offset voltage between −Vknee and zero.

A conventional Envelope Elimination and Restoration (EER) method supplies the offset voltage lower than −Vknee when the magnitude of the envelope signal is zero, and conventional systems supply the offset voltage of −Vknee when the magnitude of the envelope signal is greater than zero and less than a certain value.

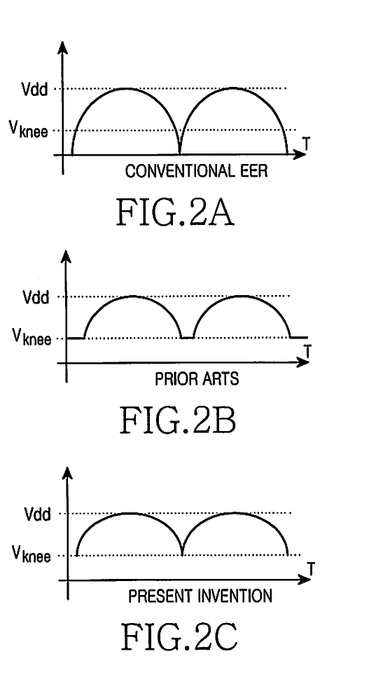

FIGS. 2A-2C illustrate the time domain of FIG. 1. The present invention, shown in FIG. 2C, supplies the offset voltage of Vknee as the minimum value. The conventional EER, shown in FIG. 2A, supplies the offset voltage less than Vknee as the minimum value. Other conventional systems, shown in FIG. 2B, supply the offset voltage of Vknee, where the time of the offset voltage Vknee maintaining the minimum value is longer than the present invention. This results in the non-linearity. The following descriptions relate to the apparatus and method of the present invention, as shown in FIG. 2C.

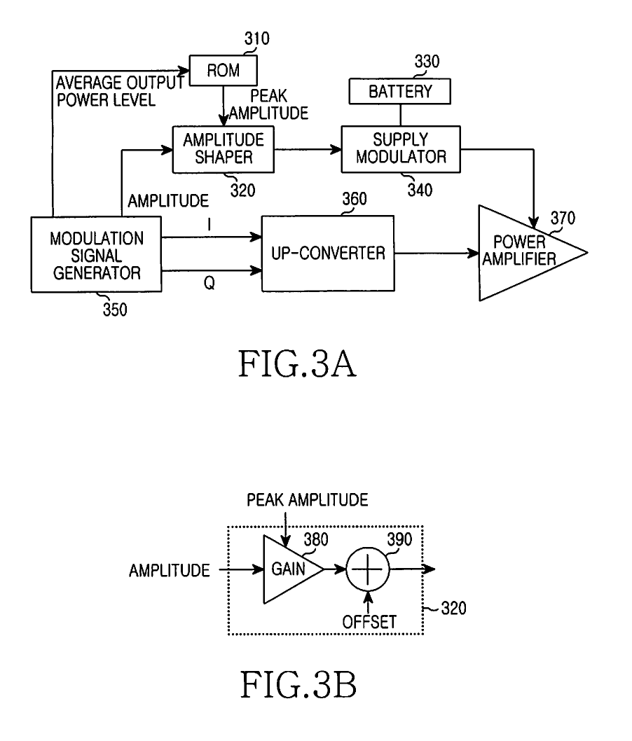

FIGS. 3A and 3B are block diagrams of an envelope (amplitude) control circuit according to an embodiment of the present invention, suitable for a portable terminal. FIG. 3A is a block diagram of the entire control circuit, and FIG. 3B is a block diagram of an amplitude shaper 320.

In FIG. 3A, the envelope control circuit includes a ROM 310, the amplitude shaper 320, a battery 330, a supply modulator 340, a modulation signal generator 350, an up-converter 360, and a power amplifier 370.

The amplitude shaper 320 generates magnitude information of the signal. The amplitude shaper 320 combines the gain added based on an amplitude generated by the modulation signal generator 350 and a peak amplitude provided from the ROM 310, and the offset information and outputs the information to the supply modulator 340 to convert to an envelope signal.

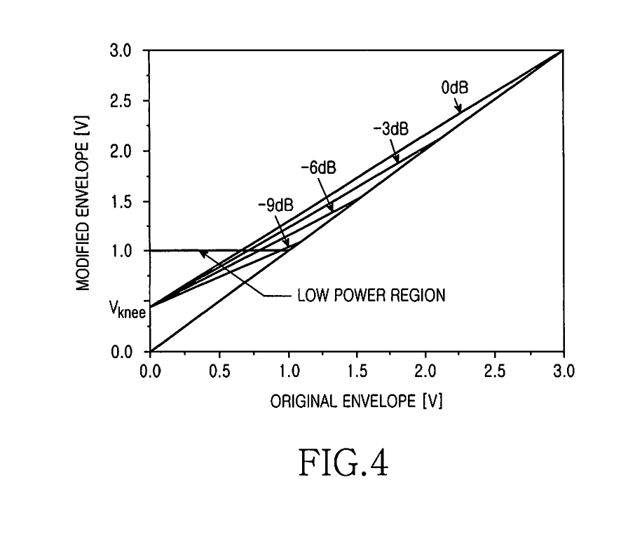

In detail, the amplitude shaper 320 supplies a signal to the supply modulator 340 by regulating the peak envelope voltage and the gain according to an average output power. An example of a transfer function of the amplitude shaper 320 is illustrated in FIG. 4, which illustrates the relation of the original envelope signal and the modified envelope.

The supply modulator 340 generates a bias voltage required by the power amplifier 370 from the magnitude information of the signal to amplify. The supply modulator 340 utilizes power of battery 330 to generate the bias voltage.

The ROM 310 receives the average output power level value from the modulation signal generator 350 and provides the peak amplitude to the amplitude shaper 320.

The modulation signal generator 350 generates a modulation signal. That is, the modulation signal generator 350 receives and modulates the decoded information and outputs the modulated information to the up-converter 360. The modulation signal generator 350 outputs the amplitude of the modulated signal to the amplitude shaper 320.

The up-converter 360 up-converts the input modulation signal and outputs the up-converted modulation signal to the power amplifier 370. The power amplifier 370 amplifies the up-converted modulation signal based on the bias voltage fed from the supply modulator 340.

The amplitude shaper 320, as shown in detail in FIG. 3B, combines the peak amplitude signal from the ROM 310 and the amplitude signal from the modulation signal generator 350 at a gain part 380 and converts the combined signal utilizing offset information at an adder 390, and outputs the combined information to the supply modulator 340. An offset information determining process can vary according to the implementation conditions.

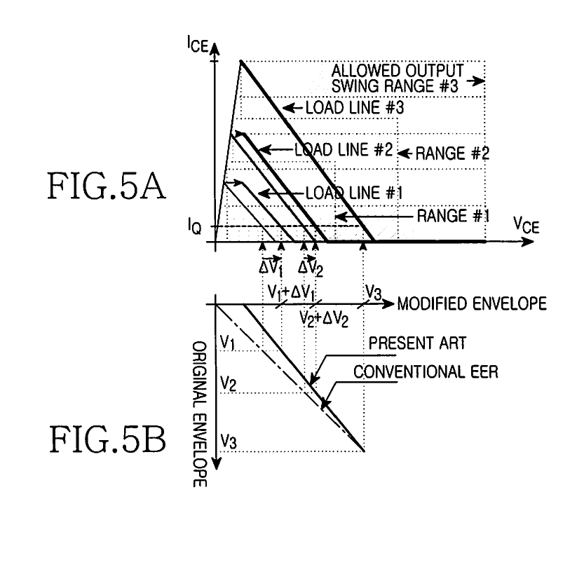

FIGS. 5A and 5B illustrate the load line of the power amplifier of FIG. 3, which always operates in the region of the output voltage greater than the knee voltage. That is, the load line varies according to the change of the envelope.

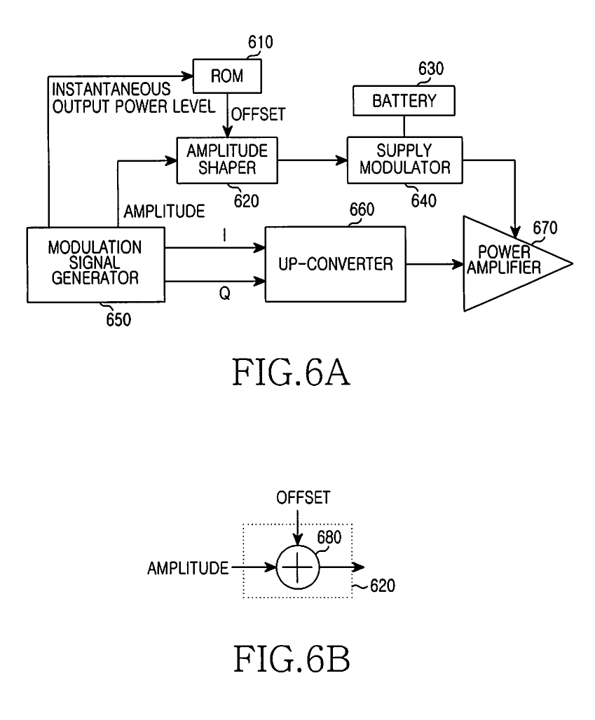

FIGS. 6A and 6B illustrate a block diagram of an envelope (amplitude) control circuit according to another embodiment of the present invention. The structure shown in FIGS. 6A and 6B is an embodiment for a base station, with FIG. 6A showing the entire control circuit and FIG. 6B showing details of an amplitude shaper 620. A difference between FIG. 6 and FIG. 3 is that the amplitude shaper 620 is an adder. The offset changes according to the instantaneous envelope magnitude, and a ROM 610 outputs an offset based on the instantaneous envelope magnitude. The offset determining process can vary according to the implementation conditions.

The envelope control circuit of FIG. 6A includes the ROM 610, the amplitude shaper 620, a battery 630, a supply modulator 640, a modulation signal generator 650, an up-converter 660, and a power amplifier 670.

The amplitude shaper 620 modulates magnitude information of the signal. The amplitude shaper 620 adds the amplitude generated by the modulation signal generator 650 and the offset provided from the ROM 610, and provides the added value to the supply modulator 640.

The supply modulator 640 generates the bias voltage required by the power amplifier 670 by converting the converted magnitude information (the amplitude plus the offset) input as the Power Amplifier 670 bias voltage. The supply modulator 640 utilizes power of battery 630 to generate the bias voltage.

The ROM 610 receives the instantaneous output power level value from the modulation signal generator 650 and provides the corresponding offset to the amplitude shaper 620.

The modulation signal generator 650 generates a modulation signal. That is, the modulation signal generator 650 receives and modulates the decoded information and outputs the modulated information to the up-converter 660. The modulation signal generator 650 outputs the amplitude of the modulated signal to the amplitude shaper 620. The modulation signal generator 650 generates and provides the instantaneous output power level value to the ROM 610.

The up-converter 660 up-converts the input modulation signal and outputs the up-converted modulation signal to the power amplifier 670. The power amplifier 670 amplifies the up-converted modulation signal based on the bias voltage provided from the supply modulator 640.

The amplitude shaper 620 shown in FIG. 6B adds the amplitude generated by the modulation signal generator 650 and the offset provided from the ROM 610, and outputs the added information to the supply modulator 640.

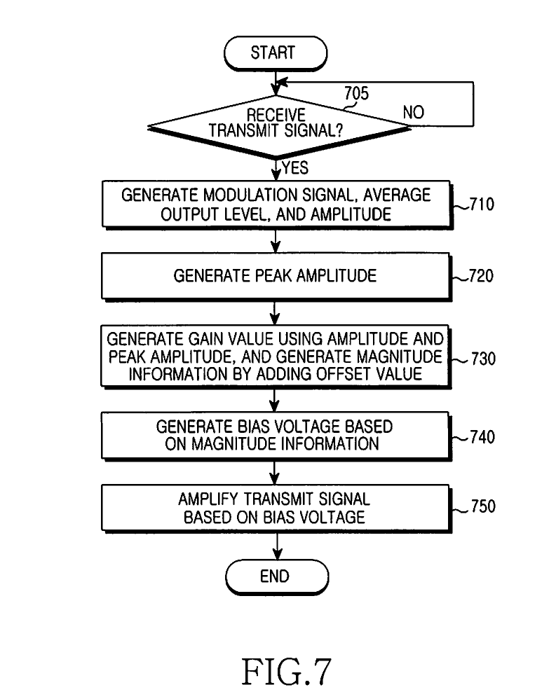

As shown in FIG. 7, when receiving a transmit signal in step 705, the modulation signal generator generates the modulation signal modulated from the transmit signal, and the average output level and the amplitude of the modulation signal in step 710. The modulation signal generator outputs the signal to the amplitude shaper, outputs the average output level to the ROM, and outputs the modulation signal to the up-converter.

The ROM receives the average output level, and generates and provides the peak amplitude to the amplitude shaper in step 720.

The amplitude shaper generates the gain value using the peak amplitude and the amplitude, generates the magnitude information by adding the gain value and the offset value, and outputs the magnitude information to the supply modulator in step 730.

The supply modulator generates the bias voltage based on the magnitude information and provides the bias voltage to the power amplifier in step 740.

The power amplifier amplifies the transmit signal based on the bias voltage provided from the supply modulator in step 750. The transmit signal is generated by the modulation signal generator and up-converted by the up-converter.

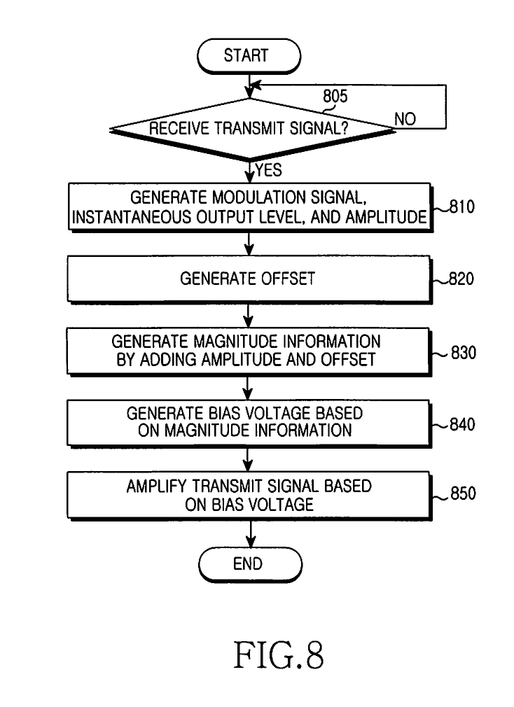

As shown in FIG. 8, in another embodiment of the present invention, when receiving a transmit signal in step 805, the modulation signal generator generates the modulation signal modulated from the transmit signal, and the instantaneous output level and the amplitude of the modulation signal in step 810. The modulation signal generator outputs the instantaneous output level to the ROM, outputs the modulation signal to the up-converter, and outputs the amplitude to the amplitude shaper.

The ROM receives the instantaneous output level, and generates and provides the offset to the amplitude shaper in step 820.

The amplitude shaper generates the magnitude information by adding the amplitude and the offset, and outputs the magnitude information to the supply modulator in step 830.

The supply modulator generates the bias voltage based on the magnitude information and provides the bias voltage to the power amplifier in step 840.

The power amplifier amplifies the transmit signal based on the bias voltage provided from the supply modulator in step 850. The transmit signal is generated by the modulation signal generator and up-converted by the up-converter.

Advantageously, the present invention does not require the additional filtering function to get rid of abrupt envelope signal changes, and does eliminates non-linearity caused by the switching operation between the constant voltage source and the time-varying envelope voltage source.

As a result of the small magnitude of the output power in the small envelope, the loss of the power amplifier caused by the offset is very tiny. The reduced offset within the larger envelope results in reduced loss of the power amplifier. Consequently, the overall efficiency improves.

The present invention is controllable based on the average output power of the terminal, in a linear relation. By making the supply voltage of the power amplifier constant when the output power is quite low, the same dynamic range as the conventional power amplifier can be attained.

Without requiring the additional pre-distortion technique in the transmitter, the present invention facilitates the implementation where the power consumption and the chip size are important as in the portable terminal.

While the invention has been shown and described with reference to preferred embodiments thereof, it will be understood by those skilled in the art that various changes and modifications in form and detail may be made therein without departing from the spirit and scope of the invention, as defined by the appended claims.

What is claimed is:

1. A transmission method for improving linearity of a terminal, the method comprising:
when receiving a transmit signal, generating, by a modulation signal generator, a modulation signal modulated from the transmit signal, an average output level and an amplitude with respect to the modulation signal;
receiving, by a Read Only Memory (ROM), the average output level and generating a peak amplitude; and
generating, by an amplitude shaper, a gain value using the peak amplitude and the amplitude, and generating magnitude information by adding an offset value.

2. The transmission method of claim 1, further comprising:
generating, by a supply modulator, a bias voltage based on the magnitude information; and
amplifying, by a power amplifier, a signal modulated based on the bias voltage.

3. The transmission method of claim 1, further comprising:
providing, by the modulation signal generator, the modulation signal to an up-converter, providing an average output level with respect to the modulation signal to the ROM, and providing the amplitude to the amplitude shaper.

4. An apparatus of a terminal for improved linear transmission, the apparatus comprising:
a modulation signal generator for, when receiving a transmit signal, generating a modulation signal modulated from the transmit signal, an average output level and an amplitude with respect to the modulation signal;
a Read Only Memory (ROM) for receiving the average output level and generating a peak amplitude; and
an amplitude shaper for generating a gain value using the peak amplitude and the amplitude and generating magnitude information by adding an offset value.

5. The apparatus of claim 4, further comprising:
a supply modulator for generating a bias voltage based on the magnitude information; and
a power amplifier for amplifying a signal modulated based on the biased voltage.

6. The apparatus of claim 4, wherein the modulation signal generator provides the modulation signal to an up-converter, provides an average output level with respect to the modulation signal to the ROM, and provides the amplitude to the amplitude shaper.

7. A transmission method for improving linearity of a base station, the method comprising:
when receiving a transmit signal, generating, by a modulation signal generator, a modulation signal modulated from the transmit signal, an instantaneous output level and an amplitude with respect to the modulation signal;
receiving, by a Read Only Memory (ROM), the instantaneous output level and generating an offset; and
generating, by an amplitude shaper, magnitude information by adding the amplitude and the offset.

8. The transmission method of claim 7, further comprising:
generating, by a supply modulator, a bias voltage based on the magnitude information; and
amplifying, by a power amplifier, a signal modulated based on the biased voltage.

9. The transmission method of claim 7, wherein the modulation signal generator provides the instantaneous output level to the ROM, provides the modulation signal to an up-converter, and provides the amplitude to the amplitude shaper.

10. An apparatus of a base station for improved linear transmission, the apparatus comprising:
a modulation signal generator for, when receiving a transmit signal, generating a modulation signal modulated from the transmit signal, an instantaneous output level and an amplitude with respect to the modulation signal;
a Read Only Memory (ROM) for receiving the instantaneous output level and generating an offset; and
an amplitude shaper for generating magnitude information by adding the amplitude and the offset.

11. The apparatus of claim 10, further comprising:
a supply modulator for generating a bias voltage based on the magnitude information; and
a power amplifier for amplifying a signal modulated based on the biased voltage.

12. The apparatus of claim 10, wherein the modulation signal generator provides the instantaneous output level to the ROM, provides the modulation signal to an up-converter, and provides the amplitude to the amplitude shaper.
